(19) United States
(12) Patent Application Publication
(10) Pub. No.: US 2015/0360837 A1
(43) Pub. Date: Dec. 17, 2015

(54) WATER SOLUBLE POUCH COMPRISING AN EMBOSSED AREA

(71) Applicant: The Procter & Gamble Company, Cincinnati, OH (US)

(72) Inventors: Eva Maria PEREZ-PRAT VINUESA, Singapore (SG); Alberto MARTINEZ BECARES, Strombeek-Bever (BE); Fung Ling YAP, Singapore (SG); Sharon Roslyn Su Yin OH, Singapore (SG); Isabel RODRIGUEZ, Singapore (SG); Hong Yee LOW, Singapore (SG)

(21) Appl. No.: 14/737,523

(22) Filed: Jun. 12, 2015

(30) Foreign Application Priority Data
Jun. 12, 2014 (EP) 14172222.3

(51) Int. Cl. B65D 65/46; B31B 29/60; C11D 17/04

(52) U.S. Cl. CPC B65D 65/46; C11D 17/042; B31B 29/60; B31B 2221/20; B31B 2221/50

(57) ABSTRACT

The present relates to a water-soluble pouch comprising a water soluble film encapsulating a composition, wherein the film comprises at least one area of embossment

### TECHNICAL FIELD

The present application relates to the field of water soluble pouches and particularly with the sealing of said water-soluble pouches.

### BACKGROUND OF THE INVENTION

Unitised, water-soluble pouch products have been growing in use over recent years. They are designed as single use products delivering a variety of products, for example laundry detergents, dishwashing detergents, bleaching composition, personal cleansing detergents etc. The pouches comprise a water soluble film which encapsulates a product within. The water soluble film dissolves on contact with water, thereby releasing the product. However, there are opportunities for improving said product. During the manufacturing process, the water soluble film, must by some design, be sealed to another or the same water-soluble film in order to make the unitsed dose pouch. The seal area can be a point of weakness if the seal is not strong enough to withstand activity thereafter. Moreover, there is a further problem when solvent is used in the sealing process, in that the presence and particularly the overuse of solvent in the sealing process can negatively impact the film integrity. Particularly, an excess of solvent spreading beyond the sealing area causes most noticeably film weakening.

It is therefore an objective of the present invention to provide a water soluble pouch with an improved seal, methods for sealing water soluble films and methods of making water soluble pouches with improved seals.

### SUMMARY OF THE INVENTION

According to the present invention there is provided a water-soluble pouch comprising a water soluble film encapsulating a composition, wherein the film comprises at least one area of embossment. According to a further aspect of the present invention there is provided a method of sealing a first embossed film, wherein the first film is according to the present invention, a second embossed film, preferably wherein the second film is according to the present invention, comprising the steps of
a) Acquiring the first embossed film and the second embossed film;
b) Optionally applying solvent to the surface of the first and/or second embossed films;
c) Contacting the embossed surface of the first embossed film with that of the second embossed film;
d) Optionally applying compression or heat to said films.

According to a further aspect of the present invention there is provided a method of manufacturing a water-soluble pouch comprising the steps of
a) preparing a water soluble film according to any preceding claim by applying embossment to said film;
b) molding said water soluble film, preferably by punch-, vacuum- and/or thermo-forming, to form a moulded cavity;
c) applying composition into said moulded cavity;
d) sealing said cavity with the same water soluble embossed film or a second water soluble embossed film.

### BRIEF DESCRIPTION OF THE DRAWINGS

FIG. 1. is a cross section Scanning Electron Microscopy image of an imprinted polyvinyl alcohol (PVA) film

FIG. 2 is a top view of the film described in FIG. 1.

### DETAILED DESCRIPTION OF THE INVENTION

The present invention provides a water soluble pouch comprising a water soluble film, encapsulating a composition, wherein said film comprises at least one area of embossment.

The composition may be any suitable composition. The composition may be a household or fabric treatment composition, even a household or fabric cleaning composition. The composition may be automatic dishwashing composition or a fabric detergent composition.

Water-Soluble Pouch

The pouches described herein may be single or multi-compartment pouches. The composition is comprised within the compartment and is enclosed by the film. Where the pouch is a multi-compartment pouch, the compartments preferably have a different aesthetic appearance. A difference in aesthetics can be achieved in any suitable way. One compartment of the pouch may be made using translucent, transparent, semi-transparent, opaque or semi-opaque film, and the second compartment of the pouch may be made using a different film selected from translucent, transparent, semi-transparent, opaque or semi-opaque film such that the appearance of the compartments is different. The compartments of the pouch may be the same size or volume. Alternatively the compartments of the pouch may have different sizes, with different internal volumes. The compartments may also be different from one another in terms of texture or colour. Hence one compartment may be glossy whilst the other is matt. This can be readily achieved as one side of a water-soluble film is often glossy, whilst the other has a matt finish. Alternatively the film used to make a compartment may be treated in a way so as to print the film. Printing may be achieved using any suitable printer and process available in the art. Alternatively, the film itself may be coloured, allowing the manufacturer to select different coloured films for each compartment. Alternatively the films may be transparent or translucent and the composition contained within may be coloured. Thus in a preferred embodiment of the present invention a first compartment has a colour selected from the group consisting of white, green, blue, orange, red, yellow, pink or purple and a second compartment has a different colour selected from the group consisting of white, yellow, orange, blue or green.

The compartments of a multi-compartment pouch can be separate, but are preferably conjoined in any suitable manner. Most preferably the second and optionally third or subsequent compartments are superimposed on the first compartment. In one embodiment, the third compartment may be superimposed on the second compartment, which is in turn superimposed on the first compartment in a sandwich configuration. Alternatively the second and third, and optionally subsequent, compartments may all be superimposed on the first compartment. However it is also equally envisaged that the first, second and optionally third and subsequent compartments may be attached to one another in a side by side relationship. In a preferred embodiment the present pouch comprises three compartments consisting of a large and two smaller compartments. The second and third smaller compartments are superposed on the first larger compartment. Alternatively, second, third and fourth smaller compartments may be superposed onto the larger compartment. The size and geometry of the compartments are chosen such that this arrangement is achievable.

The geometry of the compartments may be the same or different. In a preferred embodiment the second and optionally third or subsequent compartment has a different geometry and shape to the first compartment. In this embodiment the second and optionally third compartments are arranged in a design on the first compartment. Said design may be decorative, educative, illustrative for example to illustrate a concept or instruction, or used to indicate origin of the product. In a preferred embodiment the first compartment is the largest compartment having two large faces sealed around the perimeter. The second compartment is smaller covering less than 75%, more preferably less than 50% of the surface area of one face of the first compartment. In the embodiment wherein there is a third compartment, the above structure is the same but the second and third compartments cover less than 60%, more preferably less than 50%, even more preferably less than 45% of the surface area of one face of the first compartment.

The pouch may comprise a single film, which is sealed to itself. Alternatively, the pouch may comprise at least two films which are sealed to each other.

### Water Soluble Film

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated distilled water. Preferably such films exhibit good dissolution at temperatures 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M9467, M8310, films described in U.S. Pat. No. 6,166,117, U.S. Pat. No. 6,787,512, USPA 2011/0188784, and PVA films of corresponding solubility and deformability characteristics. Further preferred films are those described in US2006/0213801, WO 2010/119022 and U.S. Pat. No. 6,787,512.

Preferred water soluble films are those resins comprising one or more PVA polymers, preferably said water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

The PVA resin can still further include one or more additional PVA polymers that have a viscosity in a range of about 10 to about 40 cP and a degree of hydrolysis in a range of about 84% to about 92%.

When the PVA resin includes a first PVA polymer having an average viscosity less than about 11 cP and a polydispersity index in a range of about 1.8 to about 2.3, then in one type of embodiment the PVA resin contains less than about 30 wt % of the first PVA polymer. Similarly, when the PVA resin includes a first PVA polymer having an average viscosity less than about 11 cP and a polydispersity index in a range of about 1.8 to about 2.3, then in another, non-exclusive type of embodiment the PVA resin contains less than about 30 wt % of a PVA polymer having a Mw less than about 70,000 Daltons.

Of the total PVA resin content in the film described herein, the PVA resin can comprise about 30 to about 85 wt. % of the first PVA polymer, or about 45 to about 55 wt. % of the first PVA polymer. For example, the PVA resin can contain about 50 wt. % of each PVA polymer, wherein the viscosity of the first PVA polymer is about 13 cP and the viscosity of the second PVA polymer is about 23 cP.

One type of embodiment is characterized by the PVA resin including about 40 to about 85 wt % of a first PVA polymer that has a viscosity in a range of about 10 to about 15 cP and a degree of hydrolysis in a range of about 84% to about 92%. Another type of embodiment is characterized by the PVA resin including about 45 to about 55 wt % of the first PVA polymer that has a viscosity in a range of about 10 to about 15 cP and a degree of hydrolysis in a range of about 84% to about 92%. The PVA resin can include about 15 to about 60 wt % of the second PVA polymer that has a viscosity in a range of about 20 to about 25 cP and a degree of hydrolysis in a range of about 84% to about 92%. One contemplated class of embodiments is characterized by the PVA resin including about 45 to about 55 wt % of the second PVA polymer.

When the PVA resin includes a plurality of PVA polymers the PDI value of the PVA resin is greater than the PDI value of any individual, included PVA polymer. Optionally, the PDI value of the PVA resin is greater than 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, or 5.0.

Preferably the PVA resin that has a weighted, average degree of hydrolysis)( H̅°̅) between about 80 and about 92%, or between about 83 and about 90%, or about 85 and 89%. For example, H̅°̅ for a PVA resin that comprises two or more PVA polymers is calculated by the formula H̅°̅=Σ(Wi·Hᵢ) where Wᵢ is the weight percentage of the respective PVA polymer and a Hᵢ is the respective degrees of hydrolysis. Still further it is desirable to choose a PVA resin that has a weighted log viscosity ( μ̅) between about 10 and about 25, or between about 12 and 22, or between about 13.5 and about 20. The μ̅ for a PVA resin that comprises two or more PVA polymers is calculated by the formula μ̅=e^{ΣW}^{ᵢ}^{·ln μ}^{ᵢ} where is the viscosity for the respective PVA polymers.

Yet further, it is desirable to choose a PVA resin that has a Resin Selection Index (RSI) in a range of 0.255 to 0.315, or 0.260 to 0.310, or 0.265 to 0.305, or 0.270 to 0.300, or 0.275 to 0.295, preferably 0.270 to 0.300. The RSI is calculated by the formula; Σ(Wᵢ|μᵢ−μᵢ|)/Σ(Wᵢμᵢ), wherein t is seventeen, i is the average viscosity each of the respective PVOH polymers, and Wᵢ is the weight percentage of the respective PVOH polymers.

Even more preferred films are water soluble copolymer films comprising a least one negatively modified monomer with the following formula:

|Y|−[G]ₙ.

wherein Y represents a vinyl alcohol monomer and G represents a monomer comprising an anionic group and the index n is an integer of from 1 to 3. G can be any suitable comonomer capable of carrying of carrying the anionic group, more preferably G is a carboxylic acid. G is preferably selected from the group consisting of maleic acid, itaconic acid, coAMPS, acrylic acid, vinyl acetic acid, vinyl sulfonic acid, allyl sulfonic acid, ethylene sulfonic acid, 2 acrylamido 1 methyl propane sulfonic acid, 2 acrylamido 2 methyl propane sulfonic acid, 2 methyl acrylamido 2 methyl propane sulfonic acid and mixtures thereof.

The anionic group of G is preferably selected from the group consisting of OSO₃M, SO₃M, CO₂M, OCO₂M, OPO₃M₂, OPO₃HM and OPO₂M. More preferably anionic group of G is selected from the group consisting of OSO₃M, SO₃M, CO₂M, and OCO₂M. Most preferably the anionic group of G is selected from the group consisting of SO₃M and CO₂M.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film(s) of the present invention comprise(s) at least one area of embossment. By embossment, we herein mean an area of the film comprising raised portions that rise above the surface of the film. Preferably, the embossed area is printed onto the film. Preferably said area of embossment is located on one side of said film, however the film may be embossed on both sides. This may be achieved for example by bringing the film through two sequenced embossing stations, each one embossing the film on one side. During manufacturing of the pouch, it is preferred that the side of the film comprising the area of embossment is used to contact the other film and hence is used in the sealing process. The pouches of the present invention can be produced using a single film, wherein the film is folded over to encapsulate the composition within. However it is preferred that the pouch is produced using at least 2 water-soluble films. Where more than one film is used it is preferred that both films comprise an area of embossment. In one embodiment, the pouch is a multicompartment pouch. The multicompartment pouch may be arranged such that at least one compartment is orientated above another compartment, in a so called, superimposed multicompartment arrangement. In this case, the film present between the two superimposed compartments is preferably embossed on both sides. The multicompartment pouch may have a side-by-side arrangement. In this arrangement, at least one of the compartments comprises at least one embossed films.

The area of embossment may be present over the entire surface of the film, or may be present over a part of the film. The embossment may be present only in the areas where the film is sealed to another film or sealed to itself. The area of a film which is sealed to another film is referred to as the ‘seal area’. Preferably, the seal area comprises an area of embossment. The area of embossment may cover between 1 and 100% of the surface of at least one side of the film, or even from 1-50%, or even from 1-25%, or even from 1-10% of the surface of at least one side of the film.

Preferably said area of embossment is on a micrometer scale and thus produces an area of microembossment. By microembossment it is meant embossment at a micrometer level. The area of embossment comprises protrusions, wherein preferably the protrusions have a maximum height from the flat, original, unembossed film of at least 2 microns. More preferably said protrusion has a maximum height from the flat, unembossed film of from 10 to 150 microns. More preferably, said protrusions have maximum height from the flat, unembossed film of from 10 to 100 microns, and most preferably from 20 to 50 microns. Preferably said protrusions have a maximum height aspect ratio, wherein the height aspect ratio is the ratio of the height of the embossment to the width of the embossment, of more than 0.5 and less than 10, or even from 0.6 to 5, or even from 0.75 to 2.5, or even from 0.75 to 1.25. The preferred increase in surface area of the embossed area versus non-embossed film is in the range of from 1.1 to 20 times, or even from 1.2 to 10, or even from 1.3 to 7 or even from 1.75 to 5 times. Where the embossment is present on at least two films, both films may have an area of embossment with the same aspect ratio. Alternatively, where the embossment is present on at least two films, the films may have each areas of embossment having different aspect ratios.

The maximum height of the protrusion may be greater than the thickness of the film. This is because during the embossment formation process, the film may stretch to allow for a height greater than the overall thickness of the film from which it protrudes.

The areas of embossment may have any suitable shape as long as they comprise three dimensional protrusions emanating from the film. The protrusion may have any suitable shape. More preferably said protrusions have a shape selected from the group consisting of, but not limited to, 3 dimensional pyramid gratings, nodules, cube, column, “V” grooves and mixtures thereof. Most preferably said protrusions are “V” grooves (i.e. have a “V” shape as viewed from a side-on aspect). When said protrusions are “V” groove gratings the angle of the sides of the groove is preferably in the range 26° to 85°, more preferably 45° to 82°, even more preferably, preferably from 50° to 80°, and most preferably 54.7°. In one embodiment, the embossment comprises a “V” groove and has an aspect ratio and increase in surface area as detailed in the previous paragraph. When at least two films comprise embossments, the shape of the protrusions on both films may be the same type or may be different. In one embodiment, the water-soluble pouch comprises two films, wherein both films comprise embossments having “V” groove protrusions.

The protrusions may be present with any suitable pattern and frequency. However the protrusions are preferably present in a regular pattern across the film or part of the film surface. More preferably the protrusions are present in regular and equally spaced lines across the film or part of the film. The lines of protrusions may be continuous across the whole length of the film or alternatively the lines of protrusions may be non-continuous or dashed. When the lines of protrusions are non-continuous they may be aligned or offset. The protrusions of area of embossment may be present across the entire surface of the area, with no areas of flat film in between. Alternatively areas of the protrusions may be spaced apart from one another. The protrusion can have a long shape, for example where the length is at least twice the width. Alternatively, the protrusion may be a discrete shape, wherein for example the length is substantially similar to the width.

Preferably, the distance between the geometric centre of one protrusion and the geometric centre of an adjacent protrusion is from 10 to 200 μm, or even from 25 to 150 μm or even from 50 to 125 μm. Preferably, the distance between the edge of one protrusion and the edge of an adjacent protrusion is from 0.5 to 10 μm, or even from 1 to 5 μm or even from 1.5 to 3 μm. The edge of a protrusion is the point at which the protrusion starts to rise from the flat non-embossed area of film.

The film may be embossed using any suitable means. Those skilled in the art will be aware of suitable means to emboss the film. The films may be embossed as described in Nanotechnology 17 (2006) 1884-1890. In a preferred method the imprinting is conducted at a temperature between the glass transition temperature and the melting point of the water soluble film. This is the temperature range where a film can be plastically reshaped with minimal risk of losing its integrity. The film is embossed by imprinting, using a commercially available thermal nanoimprinter where temperature and pressure can be controlled. The film is imprinted at a temperature between 40° C. and 250° C., preferably between 55° C. and 150° C., and even more preferably between 80° C. and 125° C., at a pressure of between 5 bar and 60 bar, for 3 to 30 mins. These preferred conditions are the optimal conditions for achieving embossment while minimizing the impact on the chemical and physical properties of the film Imprinting can be done using a batch thermal nanoimprinter or, continuous imprinting with roll to roll, or roll to flat nanoimprinter. Embossing may be conducted on-line or off-line during pouch manufacture.

### Method of Sealing

The present invention also relates to a method of sealing a first embossed film, wherein the first film is according to the present invention, a second embossed film, preferably wherein the second film is according to the present invention, comprising the steps of
a) Acquiring the first embossed film and the second embossed film;
b) Optionally applying solvent to the surface of the first and/or second embossed films;
c) Contacting the area of embossment of the first embossed film with that of the area of embossment of the second embossed film;
d) Optionally applying compression or heat to said films.

When the method of sealing comprises the application of solvent in a solvent sealing process, preferably the solvent has viscosity of from 0.5 to 15,000 mPA·s, preferably from 1.5 to 15,000 mPa·s, preferably from 10 to 13,000 mPa·s, more preferably from 15 to 10,000 mPa·s (measured by DIN 53015 at 20° C.). Preferably the film is coated with a solvent coat having a thickness in the range from 1 μm to 100 μm, preferably from 3 μm to 50 μm. Suitable solvents for use herein are those which do not completely dissolve the film under the conditions of sealing. Preferably, the degree of dissolution is accurately controlled in order not to dissolve the area of embossment, i.e. dissolution is kept to the extent where the embossed surface improves bond strength compared to non-embossed surface with equal solvent content. When the film or films are then contacted together, the areas of dissolved film form a bond.

The viscosity of the solvent can be modified using any suitable viscosity control agent. For example, thickening agents can be added to the solvent mixture. Preferred thickening agents include thickeners of natural origin such as hydrophobically modified carboxylic acid polymers, agarose, carrageen gums, alginates, pektins, guar-gums, starch, dextrins, gelatin, casein and mixtures thereof. Organically modified thickeners of natural origin include carboxymethylcellulose, hydroxyethylcellulose, and hydroxypropylcellulose, and mixtures thereof. Fully synthetic thickeners include polyacryl and polymethacryl-compounds, vinyl polymers, polycarboxylates, polyether, polyimines, polyamides, and mixtures thereof. Especially preferred thickeners are hydrophobically modified carboxylic acid polymers such as those available from Rohm & Haas, Philadelphia, USA under the trade name Acusol.

The solvents herein preferably comprise plasticizers. These are substances used to impart flexibility, workability or stretchability to the film material. A description of plasticisers can be found in “Polyvinyl Alcohol—Properties & Applications”, Finch, J. Wiley & Sons, 1973, pp 352-362. Suitable plasticisers for use herein are those which do not completely dissolve the film when used at 20° C. Preferred plasticisers do not completely dissolve the film even at a temperature of 35° C. Preferably the solvent herein comprises from 0.1% to 99%, more preferably from 1% to 90%. Although any suitable plasticiser that meets the above criteria may be used, preferred plasticisers for use herein include glycols, glycol derivatives and mixtures thereof. Preferably the plasticisers for use herein are selected from ethylene glycol, 1,3 propanediol, 1,2 propanediol, tetramethylene glycol, pentamethylene glycol, hexamethylene glycol, glycerol, 2,3-butane diol, 1,3 butanediol, diethylene glycol, triethylene glycol, polyethylene glycols, and mixtures thereof. More preferably the plasticisers for use herein are selected from ethylene glycol, 1,3 propanediol, 1,2 propanediol, 1,3 butanediol, and mixtures thereof. Most preferred is 1,2 propanediol.

The solvent for use herein preferably comprises auxiliary substance(s) other than the plasticiser. Any suitable substance may be used (i.e. one that does not excessively damage the film during the sealing process). Preferably the solvent comprises from 1% to 99.9%, more preferably 5% to 95%, by weight of the solvent, of auxiliary substance(s). The auxiliary substances for use herein are preferably selected from pH control agents, perfumes, dyes, surfactants, other water-soluble polymers, and mixtures thereof.

Where used, said sealing solvent is preferably selected from the group consisting of glycerol, ethylene glycol, diethylene glycol, propylene glycol, sorbitol, polyvinyl alcohol solution preferably polyvinyl alcohol water solution, water and mixtures thereof.

The second film is preferably also embossed and both embossed surfaces are contacted one to the other. Preferably the shape and pattern of the embossment protrusions are such that they cooperate or ‘interlock’ with one another on contact, and sealing. The shape of the embossments may be designed to ‘interlock’ with one another. By interlock we mean complement each other such that the raised part of the embossment on one film sits within the recess between protrusions of a second film. Preferably, a first embossed film is contacted with a second embossed film, the films being oriented such that the areas of embossment face one another and interlock on contact. In one embodiment, the embossment on both films is “V” groove embossment. Alternatively the embossments may contact and ultimately join to other embossments. This latter scenario is particularly preferred when solvent is used in the sealing process. In this embodiment, solvent causes a small amount of dissolution of the water soluble film in the area of embossment. Preferably, the degree of dissolution is accurately controlled in order not to dissolve the area of embossment, i.e. dissolution is kept to the extent where the embossed surface still interlocks and improves bond strength compared to non-embossed surface with equal solvent content. When the film or films are then contacted together, the areas of dissolved film form a bond. In a further preferred aspect of this latter process, it is often preferred to perform the sealing using pressure and heat. Therefore, a preferred process involves applying solvent to the film and then applying heat and/or pressure in order to form a seal. The temperature is preferably from 30° C. to 250° C., more preferably from 50° C. to 200° C. Preferably the sealing is conducted at a temperature between the glass temperature and the melting point of the water soluble film. The pressure is preferably from 10 Nm⁻² to 1.5×10⁷ Nm⁻², more preferably from 100 Nm⁻² to 1×10⁵ Nm⁻².

### Seal Strength Method:

The tensile bond strength between PVA films was measured using the Instron 5543 Single Column Universal Testing apparatus. The tests were conducted in an environment at about 20° C. with relative humidity in the range of between 60 and 70%. The machine contains two flat platforms that travel away from each other during the testing, putting a tensile load on the sample that is adhered between them. The force for separation of the two plates is measured. The bottom platform is rigid, while the top platform has some degree of movement such that the two platforms can self-align to ensure good contact. The following steps were conducted;

The PVA films were cut to a size of approximately 1×1 cm. Both films had the same thickness. One piece was adhered using common double sided adhesive tape to the bottom platform of the instrument with the embossed side of the film facing up and the non-embossed side of the film adhered to the platform. The adhesive tape has stronger bond strength than the dry bond strength between the two embossed PVA films. The second piece was aligned with the first piece so that the protrusions in both films interlocked. This was done by sliding the second piece of PVA, with the embossed side facing the bottom piece, over the bottom piece at various angles. When the top and bottom films are out of alignment, (protrusions in both films do not interlock) they can slide over each other very easily. Once aligned, both top and bottom substrates cannot slide over each other due to the V-groove interlocking and due to the increase in frictional adhesion arising from the increase in area of contact between substrates. A piece of double sided adhesive tape, smaller than the sample size was placed on the non-embossed side of the top PVA film. The top platform was moved towards the bottom platform, once both platforms are in contact, a compressive force was applied on the sample. The sample was subjected to a compressive stress of 4N/cm² for 1 min. The platforms were moved apart vertically at 0.25 mm/min. The force required was measured by the load cell. The displacement (mm) and its corresponding load (N) was recorded. The bond stress was obtained by dividing the maximum load by the area of the film

### Composition

The composition of the present invention is preferably a liquid, but may be a solid or tablet. By the term ‘liquid’ it is meant to include liquid, paste, waxy or gel compositions. The liquid composition may comprise a solid. Solids may include powder or agglomerates, such as micro-capsules, beads, noodles or one or more pearlised balls or mixtures thereof. Such a solid element may provide a technical benefit, through the wash or as a pre-treat, delayed or sequential release component. Alternatively it may provide an aesthetic effect. The compositions of the present invention may comprise one or more of the ingredients discussed below.

### Surfactants or Detersive Surfactants

The composition of the present invention preferably comprises a surfactant. The total surfactant level may be in the range of from about 1% to 80% by weight of the composition.

Further detersive surfactants utilized can be of the anionic, nonionic, zwitterionic, ampholytic, zwitterionic, semi-polar or cationic type or can comprise compatible mixtures of these types. More preferably surfactants are selected from the group consisting of anionic, nonionic, cationic surfactants and mixtures thereof. Detergent surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, and in U.S. Pat. No. 4,239,659, Murphy, issued Dec. 16, 1980. Anionic and nonionic surfactants are preferred.

Preferred nonionic surfactants are those of the formula R¹(OC₂H₄)ₙOH, wherein R¹ is a C₁₀-C₁₆ alkyl group or a C₈-C₁₂ alkyl phenyl group, and n is from 3 to about 80. Particularly preferred are condensation products of C₁₂-C₁₅ alcohols with from about 5 to about 20 moles of ethylene oxide per mole of alcohol, e.g., C₁₂-C₁₃ alcohol condensed with about 6.5 moles of ethylene oxide per mole of alcohol.

### Detersive Enzymes

Detersive enzymes may be incorporated into the compositions of the present invention. Suitable detersive enzymes for use herein include protease, amylase, lipase, cellulase, carbohydrase including mannanase and endoglucanase, and mixtures thereof. Enzymes can be used at their art-taught levels, for example at levels recommended by suppliers. Typical levels in the compositions are from about 0.0001% to about 5%. When enzymes are present, they can be used at very low levels, e.g., from about 0.001% or lower, in certain embodiments of the invention; or they can be used in heavier-duty laundry detergent formulations in accordance with the invention at higher levels, e.g., about 0.1% and higher. In accordance with a preference of some consumers for “non-biological” detergents, the present invention includes both enzyme-containing and enzyme-free embodiments.

### Deposition Aid

Deposition aids may be incorporated into the composition of the present invention. As used herein, “deposition aid” refers to any cationic polymer or combination of cationic polymers that significantly enhance the deposition of a fabric care benefit agent onto the fabric during laundering.

Preferably, the deposition aid is a cationic or amphoteric polymer. The amphoteric polymers of the present invention will also have a net cationic charge, i.e.; the total cationic charges on these polymers will exceed the total anionic charge. Nonlimiting examples of deposition enhancing agents are cationic polysaccharides, chitosan and its derivatives and cationic synthetic polymers. Preferred cationic polysaccharides include cationic cellulose derivatives, cationic guar gum derivatives, chitosan and derivatives, cationic starches and mixtures thereof.

### Rheology Modifier

In a preferred embodiment of the present invention, the composition comprises a rheology modifier. The rheology modifier is selected from the group consisting of non-polymeric crystalline, hydroxy-functional materials, polymeric rheology modifiers which impart shear thinning characteristics to the aqueous liquid matrix of the composition. Crystalline, hydroxy-functional materials are rheology modifiers which form thread-like structuring systems throughout the matrix of the composition upon in situ crystallization in the matrix. Specific examples of preferred crystalline, hydroxyl-containing rheology modifiers include castor oil and its derivatives. Especially preferred are hydrogenated castor oil derivatives such as hydrogenated castor oil and hydrogenated castor wax. Commercially available, castor oil-based, crystalline, hydroxyl-containing rheology modifiers include THIXCIN from Rheox, Inc. (now Elementis). Polymeric rheology modifiers are preferably selected from polyacrylates, polymeric gums, other non-gum polysaccharides, and combinations of these polymeric materials. Preferred polymeric gum materials include pectine, alginate, arabinogalactan (gum Arabic), carrageenan, gellan gum, xanthan gum, guar gum and mixtures thereof.

### Builder

The compositions of the present invention may optionally comprise a builder. Suitable builders include polycarboxylate builders include cyclic compounds, particularly alicyclic compounds, such as those described in U.S. Pat. Nos. 3,923,679; 3,835,163; 4,158,635; 4,120,874 and 4,102,903. Particularly preferred are citrate builders, e.g., citric acid and soluble salts thereof, particularly sodium salts thereof.

Other preferred organic builders include aminocarboxylate builders such as salts of MGDA (methyl-glycine-diacetic acid), GLDA (glutamic-N,N-diacetic acid), EDDS (ethylene diamine disuccinates) iminodisuccinic acid (IDS) and carboxymethyl inulin. Salts of MGDA and GLDA are especially preferred herein, with the tri-sodium salt thereof being preferred and a sodium/potassium salt being specially preferred for the favourable hygroscopicity and fast dissolution properties when in particulate form.

Other suitable aminocarboxylate builders include; for example, salts of aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL) and IDS (iminodiacetic acid) such as salts of N-methyliminodiacetic acid (MIDA), alpha-alanine-N,N-diacetic acid (alpha-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N, N-diacetic acid (SLDA), taurine-N, N-diacetic acid (TUDA), ethylene diamine tetraacetic acid and salts thereof (EDTA), diethylene triamine penta acetates (DTPA) and sulfomethyl-N,N-diacetic acid (SMDA).

Other preferred builders include aluminosilicates such as zeolite A, B or MAP; fatty acids or salts, preferably sodium salts, thereof, preferably C12-C18 saturated and/or unsaturated fatty acids; and alkali or alkali earth metal carbonates preferably sodium carbonate.

### Bleaching System

Bleaching agents suitable herein include chlorine and oxygen bleaches, especially inorganic perhydrate salts such as sodium perborate mono- and tetrahydrates and sodium percarbonate optionally coated to provide controlled rate of release (see, for example, GB-A-1466799 on sulfate/carbonate coatings), preformed organic peroxyacids and mixtures thereof with organic peroxyacid bleach precursors and/or transition metal-containing bleach catalysts (especially manganese or cobalt). Inorganic perhydrate salts are typically incorporated at levels in the range from about 1% to about 40% by weight, preferably from about 2% to about 30% by weight and more preferably from about 5% to about 25% by weight of composition. Peroxyacid bleach precursors preferred for use herein include precursors of perbenzoic acid and substituted perbenzoic acid; cationic peroxyacid precursors; peracetic acid precursors such as TAED, sodium acetoxybenzene sulfonate and pentaacetylglucose; pernonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP-A-0170386); and benzoxazin peroxyacid precursors (EP-A-0332294 and EP-A-0482807). Bleach precursors are typically incorporated at levels in the range from about 0.5% to about 25%, preferably from about 1% to about 10% by weight of composition while the preformed organic peroxyacids themselves are typically incorporated at levels in the range from 0.5% to 25% by weight, more preferably from 1% to 10% by weight of composition. Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410).

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Preferably, the level of bleach in the composition of the invention is from about 1 to about 20%, more preferably from about 2 to about 15%, even more preferably from about 3 to about 12% and especially from about 4 to about 10% by weight of the composition. Preferably the second composition comprises bleach.

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.01 to about 10%, preferably from about 0.1 to about 5% and more preferably from about 1 to about 4% by weight of the total composition. If the composition comprises bleach activator then the bleach activator is preferentially placed in the second composition.

### Bleach Catalyst

The composition herein preferably contains a bleach catalyst, preferably a metal containing bleach catalyst. More preferably the metal containing bleach catalyst is a transition metal containing bleach catalyst, especially a manganese or cobalt-containing bleach catalyst.

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16.

Manganese bleach catalysts are preferred for use in the composition of the invention. Especially preferred catalyst for use here is a dinuclear manganese-complex having the general formula:

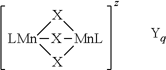

wherein Mn is manganese which can individually be in the III or IV oxidation state; each x represents a coordinating or bridging species selected from the group consisting of H2O, O22-, O2-, OH—, HO2-, SH—, S2-, >SO, Cl—, N3-, SCN—, RCOO—, NH2- and NR3, with R being H, alkyl or aryl, (optionally substituted); L is a ligand which is an organic molecule containing a number of nitrogen atoms which coordinates via all or some of its nitrogen atoms to the manganese centres; z denotes the charge of the complex and is an integer which can be positive or negative; Y is a monovalent or multivalent counter-ion, leading to charge neutrality, which is dependent upon the charge z of the complex; and q=z/[charge Y].

Preferred manganese-complexes are those wherein x is either CH₃COO⁻ or O² or mixtures thereof, most preferably wherein the manganese is in the IV oxidation state and x is O²⁻. Preferred ligands are those which coordinate via three nitrogen atoms to one of the manganese centres, preferably being of a macrocyclic nature. Particularly preferred ligands are:

(1) 1,4,7-trimethyl-1,4,7-triazacyclononane, (Me-TACN); and

(2) 1,2,4,7-tetramethyl-1,4,7-triazacyclononane, (Me-Me TACN).

The type of counter-ion Y for charge neutrality is not critical for the activity of the complex and can be selected from, for example, any of the following counter-ions: chloride; sulphate; nitrate; methylsulphate; surfanctant anions, such as the long-chain alkylsulphates, alkylsulphonates, alkylbenzenesulphonates, tosylate, trifluoromethylsulphonate, perchlorate (ClO₄⁻), BPh₄⁻, and PF₆⁻′ though some counter-ions are more preferred than others for reasons of product property and safety.

Consequently, the preferred manganese complexes useable in the present invention are:

(I) [(Me-TACN)Mn^{IV}(Âμ−0)₃Mn^{IV}(Me-TACN)]²⁺(PF₆⁻)₂

(II) [(Me-MeTACN)Mn^{IV}(Âμ−0)₃Mn^{IV}(Me-MeTACN)]²⁺(PF₆)₂

(III) [(Me-TACN)Mn^{III}(Âμ−0)(Âμ−OAc)₂Mn^{III}(Me-TACN)]²⁺(PF₆⁻)₂

(IV) [(Me-MeTACN)Mn^{III}(Âμ−0)(Âμ−OAc)₂Mn^{III}(Me-MeTACN)]²⁺(PF₆⁻)₂

which hereinafter may also be abbreviated as:

(I) [Mn^{IV}₂(Âμ−0)₃(Me-TACN)₂](PF₆)₂

(II) [Mn^{IV}₂(Âμ−0)₃(Me-MeTACN)₂](PF₆)₂

(III) [Mn^{III}₂(Âμ−0)(Âμ−OAc)₂(Me-TACN)₂](PF₆)₂

(IV) [Mn^{III}₂(Āμ−0)(Âμ−OAc)₂(Me-TACN)₂](PF₆)₂

The structure of I is given below:

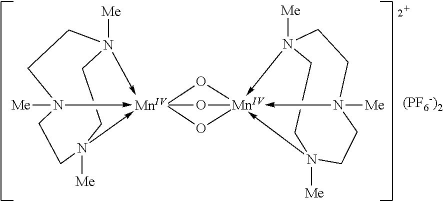

abbreviated as [Mn^{IV}₂(Āμ−0)₃(Me-TACN)₂](PF₆)₂.
The structure of II is given below:

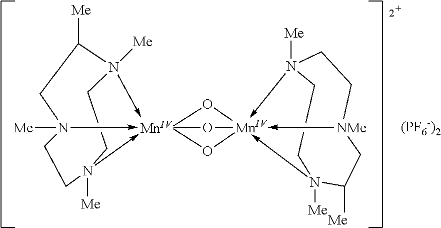

abbreviated as [Mn^{IV}₂(Âμ−0)₃(Me-MeTACN)₂](PF₆)₂.

It is of note that the manganese complexes are also disclosed in EP-A-0458397 and EP-A-0458398 as unusually effective bleach and oxidation catalysts. In the further description of this invention they will also be simply referred to as the “catalyst”.

Bleach catalyst are included in the compositions of the invention are in a preferred level of from about 0.001 to about 10%, preferably from about 0.05 to about 2% by weight of the total composition.

### Fabric Care Benefit Agents

The compositions may comprise a fabric care benefit agent. As used herein, “fabric care benefit agent” refers to any material that can provide fabric care benefits such as fabric softening, color protection, pill/fuzz reduction, anti-abrasion, anti-wrinkle, and the like to garments and fabrics, particularly on cotton and cotton-rich garments and fabrics, when an adequate amount of the material is present on the garment/fabric. Non-limiting examples of fabric care benefit agents include cationic surfactants, silicones, polyolefin waxes, latexes, oily sugar derivatives, cationic polysaccharides, polyurethanes, fatty acids and mixtures thereof. Fabric care benefit agents when present in the composition, are suitably at levels of up to about 30% by weight of the composition, more typically from about 1% to about 20%, preferably from about 2% to about 10%.

### Automatic Dishwashing Benefit Agents

The compositions may comprise a automatic dishwashing care benefit agent. As used herein, “automatic dishwashing care benefit agent” refers to any material that can provide shine, fast drying, metal, glass or plastic protection benefits. Non-limiting examples of automatic dishwashing care benefit agents include organic shine polymers, especially sulfonated/carboxylated polymers, surface modifying polymers or surfactants inducing fast drying, metal care agents like benzatriazoles and metal salts including Zinc salts, and anti-corrosion agents including silicates e.g. sodium silicate.

### Other Adjuncts

Examples of other suitable cleaning adjunct materials include, but are not limited to; enzyme stabilizing systems; antioxidants, opacifier, pearlescent agent, hueing dye, scavenging agents including fixing agents for anionic dyes, complexing agents for anionic surfactants, and mixtures thereof; optical brighteners or fluorescers; soil release polymers; dispersants; suds suppressors; dyes; colorants; hydrotropes such as toluenesulfonates, cumenesulfonates and naphthalenesulfonates; color speckles; perfumes and perfume microcapsules, colored beads, spheres or extrudates; clay softening agents, alkalinity sources and mixtures thereof.

### Composition Preparation

The compositions herein can generally be prepared by mixing the ingredients together. If a pearlescent material is used it should be added in the late stages of mixing. If a rheology modifier is used, it is preferred to first form a pre-mix within which the rheology modifier is dispersed in a portion of the water and optionally other ingredients eventually used to comprise the compositions. This pre-mix is formed in such a way that it forms a structured liquid. To this structured pre-mix can then be added, while the pre-mix is under agitation, the surfactant(s) and essential laundry adjunct materials, along with water and whatever optional detergent composition adjuncts are to be used.

### Process for Making Unitized Dose Pouch Product

Pouches may be made using any suitable equipment and method. Single compartment pouches are made using vertical, but preferably horizontal form filling techniques commonly known in the art. The film is preferably dampened, more preferably heated to increase the malleability thereof. Even more preferably, the method also involves the use of a vacuum to draw the film into a suitable mould. The vacuum drawing the film into the mould can be applied for 0.2 to 5 seconds, preferably 0.3 to 3 or even more preferably 0.5 to 1.5 seconds, once the film is on the horizontal portion of the surface. This vacuum may preferably be such that it provides an ‘under-pressure’ (i.e. pressure that pulls film into the mould) of between +10 mbar to +1000 mbar, more preferably from +100 mbar to +600 mbar.

The moulds, in which the pouches are made, can have any shape, length, width and depth, depending on the required dimensions of the pouches. The moulds can also vary in size and shape from one to another, if desirable. For example, it may be preferred that the volume of the final pouches is between 5 and 300 ml, or even 10 and 150 ml or even 20 and 100 ml and that the mould sizes are adjusted accordingly.

Heat can be applied to the film, in the process commonly known as thermoforming, by any means. For example the film may be heated directly by passing it under a heating element or through hot air, prior to feeding it onto the surface or once on the surface. Alternatively it may be heated indirectly, for example by heating the surface or applying a hot item onto the film. Most preferably the film is heated using an infra red light. The film is preferably heated to a temperature of 50 to 120° C., or even 60 to 90° C. Alternatively, the film can be wetted by any mean, for example directly by spraying a wetting agent (including water, solutions of the film material or plasticizers for the film material) onto the film, prior to feeding it onto the surface or once on the surface, or indirectly by wetting the surface or by applying a wet item onto the film.

Once a film has been heated/wetted, it is drawn into an appropriate mould, preferably using a vacuum. The filling of the moulded film can be done by any known method for filling (preferably moving) items. The most preferred method will depend on the product form and speed of filling required. Preferably the moulded film is filled by in-line filling techniques. The filled, open pouches are then closed, using a second film, by any suitable method. Preferably, this is also done while in horizontal position and in continuous, constant motion. Preferably the closing is done by continuously feeding a second film, preferably water-soluble film, over and onto the open pouches and then preferably sealing the first and second film together, typically in the area between the moulds and thus between the pouches. The open pouch may be sealed using a separately prepared second pouch.

Preferred methods of sealing include dry, heat sealing, solvent welding, and solvent or wet sealing. It is preferred that only the area which is to form the seal, is treated with heat or solvent. The heat or solvent can be applied by any method, preferably on the closing material, preferably only on the areas which are to form the seal. If solvent or wet sealing or welding is used, it may be preferred that heat is also applied. Preferred wet or solvent sealing/welding methods include applying selectively solvent onto the area between the moulds, or on the closing material, by for example, spraying or printing this onto these areas, and then applying pressure onto these areas, to form the seal. Sealing rolls and belts as described above (optionally also providing heat) can be used, for example. Preferably the method of sealing is dry sealing.

The present invention also relates to a method of manufacturing a water-soluble pouch comprising the steps of
a) preparing a water soluble film according to the present invention by applying embossment to said film;
b) molding said water soluble film, preferably by punch-, vacuum- and/or thermo-forming, to form a moulded cavity;
c) applying composition into said moulded cavity;
d) sealing said cavity with the same water soluble embossed film or a second water soluble embossed film.
   A first and second water soluble film may be used and which case, both films comprise an area of embossment. In a further preferred aspect, the sealing step (d) optionally comprises the application of sealing solvent.

The embossment may cover between 1 and 100% of the surface of at least one side of each of the first or second films, or even from 1-50%, or even from 1-25%, or even from 1-10% of the surface of at least one side of at least one of the films.

The formed pouches can then be cut by a cutting device. Cutting can be done using any known method. It may be preferred that the cutting is also done in continuous manner, and preferably with constant speed and preferably while in horizontal position. The cutting device can, for example, be a sharp item or a hot item, whereby in the latter case, the hot item ‘burns’ through the film/sealing area. Cutting may also be achieved using radiation, such as laser, or by chemical means.

The different compartments of a multi-compartment pouch may be made together in a side-by-side style and consecutive pouches are not cut. Alternatively, the compartments can be made separately. According to this process and preferred arrangement, the pouches are made according to the process comprising the steps of:

a) forming an first compartment (preferably as described above);
b) forming a recess within some or all of the closed compartment formed in step (a), to generate a second moulded compartment superposed above the first compartment;
c) filling and closing the second compartments by means of a third film;

d) sealing said first, second and third films; and
e) cutting the films to produce a multi-compartment pouch.

Said recess formed in step b is preferably achieved by applying a vacuum to the compartment prepared in step a). In this process, preferably the first, the second and optionally the third films comprise an area of embossment. Where a film is intended to be used between and sealed to two other films, then it is preferred that both sides of said film comprise areas of embossment.

Alternatively the second, and optionally third, compartment(s) can be made in a separate step and then combined with the first compartment. A particularly preferred process comprises the steps of:
a) forming a first compartment, optionally using heat and/or vacuum, using a first film on a first forming machine;
b) filling said first compartment with a first composition;
c) on a second forming machine, deforming a second film, optionally using heat and vacuum, to make a second and optionally third moulded compartment;
d) filling the second and optionally third compartments;
e) sealing the second and optionally third compartment using a third film;
f) placing the sealed second and optionally third compartments onto the first compartment;
g) sealing the first, second and optionally third compartments; and
h) cutting the films to produce a multi-compartment pouch
   The first and second forming machines are selected based on their suitability to perform the above process. The first forming machine is preferably a horizontal forming machine. The second forming machine is preferably a rotary drum forming machine, preferably located above the first forming machine. In this process, preferably the first, and the second and optionally the third films comprise an area of embossment. Where a film is intended to be used between and sealed to two other films, then it is preferred that both sides of said film comprise areas of embossment.

It will be understood moreover that by the use of appropriate feed stations, it is possible to manufacture multi-compartment pouches incorporating a number of different or distinctive compositions and/or different or distinctive liquid, gel or paste compositions.

### Secondary Packaging

The multi-compartment pouches of the present invention are preferably further packaged in an outer package. Said outer package may be a see-through or partially see-through container, for example a transparent or translucent bag, tub, carton or bottle. The pack can be made of plastic or any other suitable material, provided the material is strong enough to protect the pouches during transport. This kind of pack is also very useful because the user does not need to open the pack to see how many pouches there are left. Alternatively, the pack can have non-see-through outer packaging, perhaps with indicia or artwork representing the visually-distinctive contents of the pack.

### Process of Washing

The pouches of the present invention are suitable for cleaning applications, particularly laundry or dishwashing applications. The pouches are suitable for hand or machine washing conditions. When machine washing, the pouch may be delivered from the dispensing drawer or may be added directly into the washing machine drum.

### EXAMPLES

### Example 1

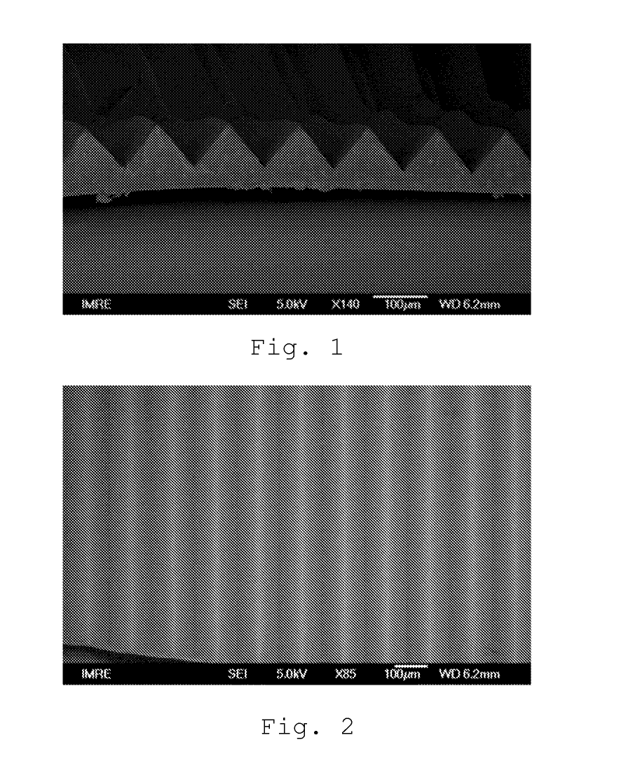

FIG. 1. is a transversal Scanning Electron Microscopy image of an imprinted polyvinyl alcohol (PVA) film. It shows an image of embossed PVA with 100 μm “V” groove gratings.

FIG. 2 is a top view of the film described in FIG. 1.

### Example 2

### Bond Strength of Embossed Films Versus Non-Embossed Films

The table below illustrates the bond strength between two embossed PVA films (average of three measurements with standard deviation) having 40 μm V grove gratings or 100 μm V-groove gratings versus two non-embossed PVA films Imprinting of the embossed PVA films was done at 120° C., 30 bar, 3 min for both patterns. The embossment process was performed using an Obducat nanoimprinter. The PVA film was placed on top of the mold. The mold and the PVA film were heated to 120° C. and a pressure of 30 bar was applied for 3 min. At the end of the process, the system was cooled to 40° C. and the pressure was released. The embossed PVA film was subsequently detached from the mold.

The bond strength was measured using an Instron 5543 Single Column Universal Testing apparatus according to the dry bond strength method described herein. A comparison was made against a film of equal size and thickness. The results can be seen in Table 1.

TABLE 1

| | Bond Strength * | Standard Deviation |
|---|---|---|
| Film | (N/cm²) | (N/cm²) |
| Non-embossed | 0.15 | 0.16 |
| 40 μm V groove | 3.08 | 0.42 |
| 100 μm V groove | 6.45 | 1.70 |

* Average of three different tests

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 μm” is intended to mean “about 40 μm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble pouch comprising a water soluble film encapsulating a composition, wherein the film comprises at least one area of embossment.

2. A water-soluble pouch according to claim 1, wherein the pouch comprises a seal area and wherein the area of embossment is present in the seal area.

3. A water soluble pouch according to claim 1, wherein the area of embossment is present on one side of said water soluble film.

4. A water soluble pouch according to claim 1, comprising at least a first and a second water soluble film, wherein each film comprises an area of embossment.

5. A water soluble pouch according to claim 4, wherein the films are adhered to one another along the seal area of each film and wherein the seal area comprises the area of embossment.

6. A water soluble pouch according to claim 4, wherein at least one embossed film is adhered to another film with the addition of a solvent between said films.

7. A water soluble pouch according to claim 6, wherein the area of embossment is adhered to the other film.

8. A water soluble pouch according to claim 1, wherein the area of embossment is an area of microembossment.

9. A water soluble pouch according to claim 1, wherein the area of embossment covers between 1 and 99% of at least one surface of the film.

10. A water soluble film according to claim 9, wherein the area of embossment covers between 1 and 50% of the surface of at least one side of the film.

11. A water soluble pouch according to claim 1, wherein the area of embossment comprises protrusions, wherein the protrusions have a height aspect ratio of greater than 0.5 and less than 10.

12. A water soluble film according to claim 11, wherein the protrusions have a height aspect ratio of from 0.6 to 5.

13. A water soluble pouch according to claim 1, wherein the area of embossment is capable of interlocking with another area of embossment.

14. A water soluble film according to claim 13, wherein the shape of protrusions are selected from the group consisting of 3 dimensional pyramid, bar, node, cube, column, “V” groove and mixtures thereof.

15. A water soluble pouch according to claim 1, wherein the pouch is a multicompartment pouch.

16. A water soluble pouch according to claim 15, wherein the multicompartment pouch has a superposed arrangement wherein at least one film comprises an embossment on both sides.

17. A method of sealing a first embossed film, wherein the first film is according to claim 1, a second embossed film, comprising the steps of
a) acquiring the first embossed film and the second embossed film;
b) optionally applying solvent to the surface of the first and/or second embossed films;
c) contacting the area of embossment of the first embossed film with the area of embossment of the second embossed film;
d) optionally applying compression or heat to said films.

18. A method according to claim 17 wherein the first embossed film is contacted with the second embossed film, the films being orientated such that the areas of embossment face one another and interlock on contact.

19. A method of manufacturing a water-soluble pouch comprising the steps of
a) preparing a water soluble film according to claim 1 by applying embossment to said film;
b) molding said water soluble film to form a moulded cavity;
c) applying composition into said moulded cavity;
d) sealing said cavity with the same water soluble embossed film or a second water soluble embossed film.

20. A method according to claim 19, wherein a first and second water soluble film are used and both films comprise an area of embossment.
